(19) United States
(12) Patent Application Publication
(10) Pub. No.: US 2017/0109924 A1
(43) Pub. Date: Apr. 20, 2017

(54) OBJECT RETOPOLOGIZER HOLE REFILLER AND METHOD OF RETOPOLOGIZING HOLE REFILLING

(71) Applicant: Gary Arnold Crocker, San Diego, CA (US)

(72) Inventor: Gary Arnold Crocker, San Diego, CA (US)

(73) Assignee: IntegrityWare, Inc., San Diego, CA (US)

(21) Appl. No.: 14/882,975

(22) Filed: Oct. 14, 2015

(51) Int. Cl. G06T 17/20; H04N 1/00

(52) U.S. Cl. CPC G06T 17/20; H04N 1/00827

(57) ABSTRACT

A method and system for creating and refilling holes in image data is disclosed herein. The method can include receiving scanned image data that represents a tangible object, and that can be generated by an object scanner from the tangible object and converting the scanned image data to polygonal data that can be a collection of vertices, edges and faces. The method can include identifying geometry in the polygonal data for hole cutting and cutting a hole by removing the identified geometry from the scanned image data. The method can include generating modified polygonal data by filling the cut hole with polygonal data and outputting the modified polygonal data.

### BACKGROUND OF THE INVENTION

This disclosure relates in general, but not by way of limitation, to graphic retopologization.

During graphical design processes, tangible objects can be converted into electronic form via one or several scanning processes. This electronic form can be unorganized and thus difficult to control, edit, and/or manipulate, and can be large and thus require significant computing resources to control, edit and/or manipulate. Accordingly, new methods for retopologizing are desired.

### BRIEF SUMMARY OF THE INVENTION

One aspect of the present disclosure relates to a method of hole refilling. The method includes receiving scanned image data. In some embodiments, the scanned image data represents a tangible object and the scanned image data is generated by an object scanner from the tangible object. The method can include converting the scanned image data to polygonal data, which polygonal data is a collection of nodes, points, or vertices, edges or links, and faces, surfaces, or cells, identifying geometry in the polygonal data for hole cutting, which identified geometry is specified by a user, and cutting a hole by removing the identified geometry from the scanned image data. In some embodiments, the method can include generating modified polygonal data by filling the cut hole with polygonal data. In some embodiments, filling the hole includes attaching a polygonal surface to a surface around the cut hole, which polygonal surface is continuous with the surface around the hole. The method can include outputting the modified polygonal data.

In some embodiments, the object scanner is a 3D object scanner. In some embodiments, the method can include identifying a continuous surface that is continuous at all locations around the hole when applied to the hole. In some embodiments, the polygonal surface is adjusted to match the continuous surface.

In some embodiments, the polygonal surface is G2 continuous with the surface around the hole, and in some embodiments, the polygonal surface is G3 continuous with the surface around the hole. In some embodiments, the method includes smoothing the polygonal surface, and in some embodiments, the surface is smoothed via a Catmull-Clark subdivision.

One aspect of the present disclosure relates to a non-transitory computer readable medium storing computer executable program code for hole refilling. The non-transitory computer readable medium can include code for receiving scanned image data, which scanned image data represents a tangible object, and which scanned image data is generated by an object scanner from the tangible object; code for converting the scanned image data to polygonal data, which polygonal data is a collection of nodes, points, or vertices, edges or links, and faces, surfaces, or cells; code for identifying geometry in the polygonal data for hole cutting, which identified geometry is specified by a user; and code for cutting a hole by removing the identified geometry from the scanned image data. In some embodiments, the non-transitory computer readable medium can include code for generating modified polygonal data by filling the cut hole with polygonal data, which filling the hole can include attaching a polygonal surface to a surface around the cut hole, which polygonal surface is continuous with the surface around the hole; and code for outputting the modified polygonal data.

In some embodiments, the object scanner is a 3D object scanner. In some embodiments, the non-transitory computer readable medium can include code for identifying a continuous surface, wherein the continuous surface is continuous at all locations around the hole when applied to the hole. In some embodiments, the polygonal surface is adjusted to match the continuous surface.

In some embodiments, the polygonal surface is G2 continuous with the surface around the hole, and in some embodiments, the polygonal surface is G3 continuous with the surface around the hole. In some embodiments, the non-transitory computer readable medium can include code for smoothing the polygonal surface, and in some embodiments, the surface is smoothed via a Catmull-Clark subdivision.

One aspect of the present disclosure relates to a system for refilling a hole generated in image data. The system includes an object scanner that can generate scanned image data of a tangible object, and memory including stored instructions to control a processor. In some embodiments, the stored instructions can control the processor to: receive scanned image data, which scanned image data represents a tangible object, and which scanned image data is generated by the object scanner from the tangible object; convert the scanned image data to polygonal data, which polygonal data is a collection of nodes, points, or vertices, edges or links, and faces, surfaces, or cells; identify geometry in the polygonal data for hole cutting, which identified geometry is specified by a user; cut a hole by removing the identified geometry from the scanned image data; generate modified polygonal data by filling the cut hole with polygonal data, which filling the hole includes attaching a polygonal surface to a surface around the cut hole, which polygonal surface is continuous with the surface around the hole; and output the modified polygonal data. In some embodiments, the system can include a processor controllable according to the stored instructions.

In some embodiments, the object scanner is a 3D object scanner. In some embodiments, the stored instructions can further control the processor to identify a continuous surface, which continuous surface is continuous at all locations around the hole when applied to the hole. In some embodiments, the polygonal surface is adjusted to match the continuous surface.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a perspective view of one embodiment of image data;

FIG. 2 is a flowchart illustrating one embodiment of a process for generating and displaying simplified image data;

FIG. 3 depicts one embodiment of image data containing a hole;

FIG. 4 is a flowchart illustrating one embodiment of a process for simplifying retopologized data;

FIG. 5 is a flowchart illustrating one embodiment of a process for identifying one or several boundary errors;

FIG. 6 is a depiction of cell overlap and resolution;

FIG. 7 is a depiction of cell shape and shape resolution;

FIG. 8 is a flowchart illustrating one embodiment of a process for simplifying retopologized data with paving;

FIG. 9 shows a configuration of a computer system constructed in accordance with the present disclosure.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Electronic image data is the backbone of many modern engineering and entertainment applications. In these different applications, different features and image attributes are desired. For example, in engineering design applications, volumes of data and image detail are desired so that planned products can be completely designed, and so that different analysis of those products can be performed. However, this level of detail can be detrimental in other applications and the amounts of data required in a complex model can result in slower processing times and can make a model more cumbersome to work with. In such situations, as well as in other situations, it can be advantageous if the level of detail of a model or of image data can be controlled by allowing a user to remove portions of the image data and replace those removed portions with one or several surfaces.

Image data, also referred to herein as electronic image data, can be any data that forms an image can be received or generated. In some embodiments, image data can be formed by a scanner such as, for example, an object scanner including a 3D object scanner. This image data can be generated by the placement of an object, and specifically of a tangible object so as to be scannable by the scanner, and scanning the tangible object with the scanner.

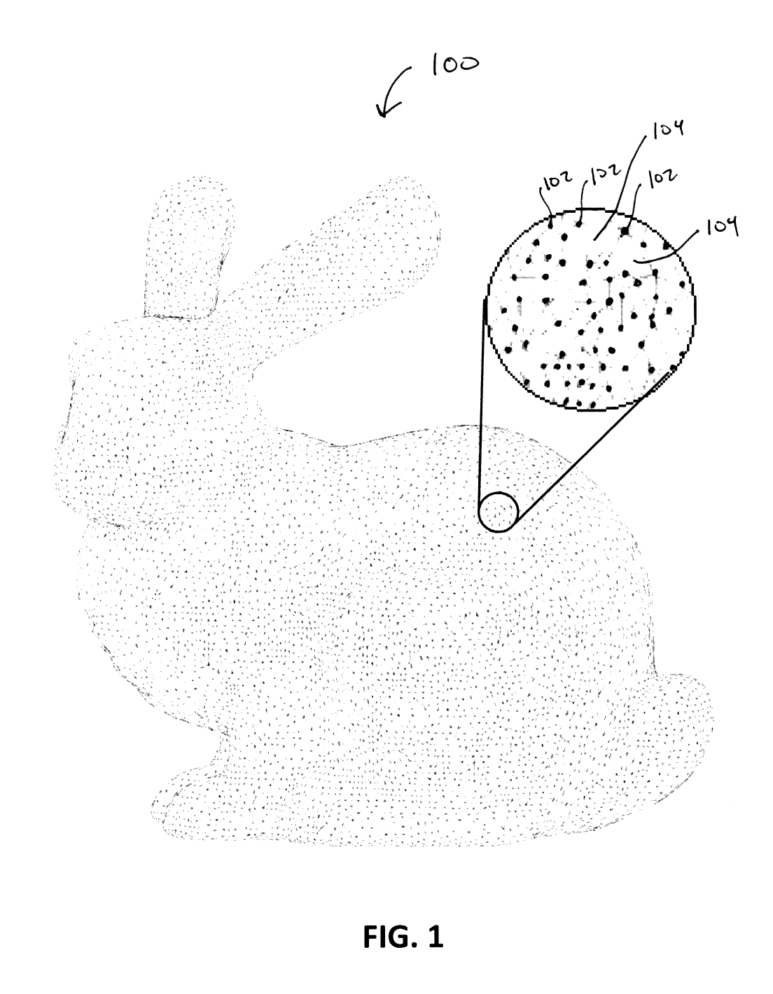

This image data output by the scanner can comprise a plurality of points located in space. In some embodiments, each of these points can correspond to a location of the tangible object as detected by the scanner. In some embodiments, these points can be linked, and in some embodiments, these points can be unlinked. FIG. 1 depicts one embodiment of image data 100 that can be generated by a scanned image. As seen in FIG. 1, the image data 100 depicts a rabbit, and the image data comprises a plurality of points 102 that together define the surface of the rabbit. In FIG. 1, these points 102 are linked together by edges in groups of threes to form a plurality of triangles or triangular polygons or triangular surfaces 104.

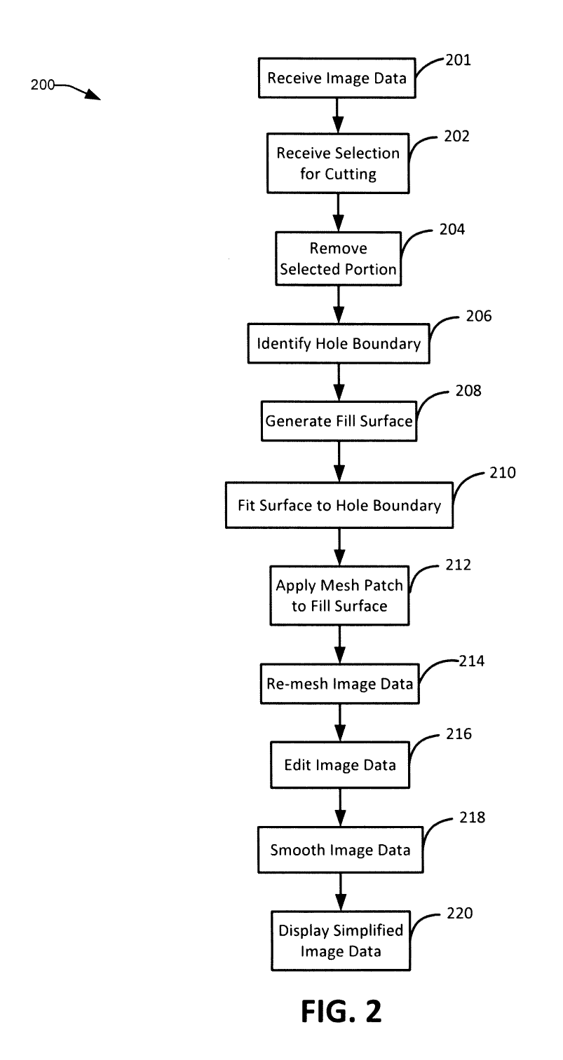

With the image data received and/or generated, one of several embodiments can be used to remove portions of the image data and replace those removed portions. A first embodiment is depicted in the process 200 for generating and displaying simplified image data in FIG. 2. Each of the steps of the process 200 and other steps of methods described herein may be performed by a system in response to an indication from a user. In some embodiments, a single indication causes the system to automatically perform one or more of the steps. The process 200 begins at block 201, wherein the image data is received. In some embodiments, the image data can be received from, memory and in some embodiments, the image data can be received form the scanner.

After the image data has been received, the process 200 proceeds to block 202, wherein a selection of a cutting portion is received. In some embodiments, the cutting portion can identify one or several portions of the image data and/or features in the image data for removal from the image data. In some embodiments, the cutting portion can be selected by the user through a variety of methods including, for example, through the use of a selection tool and a mouse, trackpad, or the like.

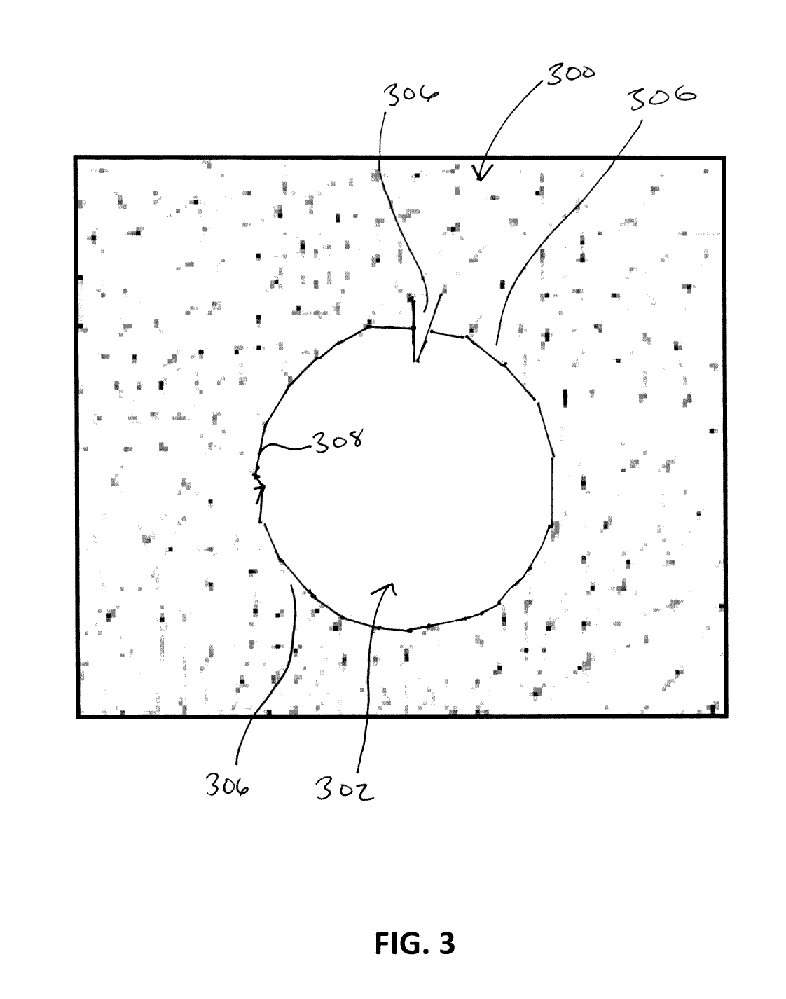

After the cutting portion has been received, the process 200 proceeds to block 20, wherein the cutting portion is removed from the image data. In some embodiments, the cutting portion can be removed from the image data by identifying the portions of the image data, such as, for example, the nodes, edges, and/or surfaces within the cutting portion, and deleting those identified portions of the image data. In some embodiments, the removal of the cutting portion for the image data can create a hole 302 in a portion of the image data 300 as depicted in FIG. 3.

After the cutting portion has been removed, the process 200 proceeds to block 206, wherein the hole boundary is identified. As seen in FIG. 3, the hole 302 is surrounded by a plurality of cells 306 and the hole is defined by a boundary 308. In some embodiments, the hole boundary is defined by the one or several nodes, edges, and/or surfaces that are directly adjacent to the hole. In some embodiments, the identification of the hole boundary can further include the determination of one or several attributes of the image data at the hole boundary. These one or several attributes can include, for example, attributes of the surface of the image data and the hole boundary including, for example, an integral of the surface at one or several points along all or portions of the hole boundary. In some embodiments, this integral can be, for example, at least one of the first, second, and third integrals at one or several points along the hole boundary.

After the hole boundary has been identified, the process 200 proceeds to block 208, wherein a fill surface is generated. In some embodiments, the fill surface can be a surface that can be placed over the hole and used to locate one a patch in the image data, which patch covers or fills the hole.

After the fill surface has been generated, the process 200 proceeds to block 210, wherein the fill surface is fit to the hole boundary. In some embodiments, this can include defining one or several boundaries of the fill surface to match the hole boundary. In some embodiments, this can further include matching one or several attributes of the fill surface to match one or several attributes of the hole boundary such as the integral of the hole boundary at one or several points along all or portions of the hole boundary or at one or several points adjacent or near the boundary. In some embodiments, this matching can eliminate discontinuities between the image data and the fill surface. In some embodiments, for example, the fill surface can be, G1, G2, and/or G3 continuous with the image data at all or portions of the hole boundary.

After the fill surface has been fit to the hole boundary, the process 200 proceeds to block 212, wherein a patch is applied to the fill surface, such that geometries of the patch match or lie on the fill surface. By applying the patch to the fill surface, the patch may have the same size and/or shape as the fill surface. Advantageously, this can result in the patch being at least one of G1, G2, and G3 continuous with the image data along all or portions of the hole boundary.

After the patch has been applied to the fill surface, the process 200 proceeds to block 214, wherein the image data is re-meshed. In some embodiments, this re-meshing of the image data can include the retopologizing of the image data. This re-meshing of the image data, including the patch can result in the integration of the patch data into the re-meshed image data. In some embodiments, this re-meshing can further improve the quality of the image data by decreasing the number of points, nodes, vertices, edges, and/or surfaces in the image data.

After the image data and the patch have been re-meshed, the process 200 proceeds to block 216, wherein the image data is edited. In some embodiments, this editing of the image data can include changing an attribute of one or several of the nodes, edges, and/or surfaces, which attributes can include, for example, a location, shape, length, size, or the like. In some embodiments, the image data can be edited based on one or several inputs received from the user.

After the image data has been edited, the process 200 proceeds to block 218, wherein the image data is smoothed. In some embodiments, the image data can be smoothed via the application of one or several smoothing algorithms to the image data. These one or several smoothing algorithms can include, for example, a Catmull-Clark subdivision algorithm.

After the image data has been smoothed, the process 200 proceeds to block 220, wherein the image data, which is now simplified via the removal of the cutting portion, is displayed or otherwise provided to the user, and/or stored in an electronic memory. In some embodiments the simplified image data can be displayed to the user on one or several displays, screens, monitors, or the like.

In some embodiments, the patch can comprise mesh data corresponding to the mesh of the image data, and thus, in some embodiments in which the image data comprises a triangular mesh as depicted in FIG. 1, the patch can comprise a triangular mesh. Similarly, in some embodiments in which the image data comprises a polygonal quad-mesh, the patch can comprise a polygonal quad-mesh. Further, in some embodiments, the size of the mesh can be configured to correspond to the size of the mesh of the image data.

In some embodiments, the image data 100 includes an error produced in the scanning process, where the error includes a missing portion of the image data 100. Such an error may be similar to the hole 302 of FIG. 3. Steps 206 through 220 may be performed on the image data 100 so as to effectively fix the error in the scanned image data 100.

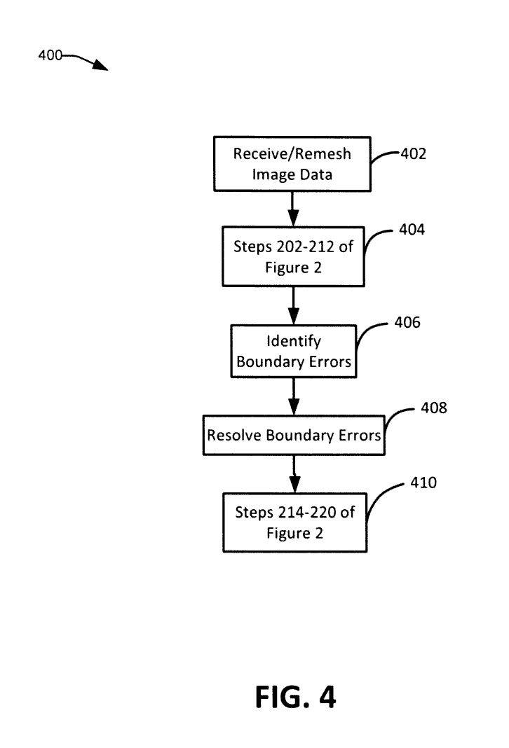

With reference now to FIG. 4, a flowchart illustrating one embodiment of a process 400 for simplifying retopologized data is shown. The process begins at block 402, wherein image data is received, as discussed above in step 201 of FIG. 2, and wherein the image data is retopologized or re-meshed. In some embodiments, after scanning the particular object, the data of the scan is retopologized to generate re-meshed image data, also referred to herein as a data mesh. Retopologizing may be performed, for example, to convert polygonal data of a less desirable constitution to a more preferred state. For example, data having many small triangular faces, such as a scanned mesh generated by the scanner may be retopologized to create a data mesh having significantly fewer quadrilateral faces. Brep data, subdivided data, a triangular mesh, volumetric representation data, quad-tree data, oct-tree data, or other data may also be preferably retopologized to generate the reference geometry, or a scan mesh.

In some embodiments of the process of retopologizing, the process includes one or more aspects or features of the retopologizing processes discussed in U.S. application Ser. No. 13/447,111, filed Apr. 13, 2012, which is incorporated herein by reference for all purposes.

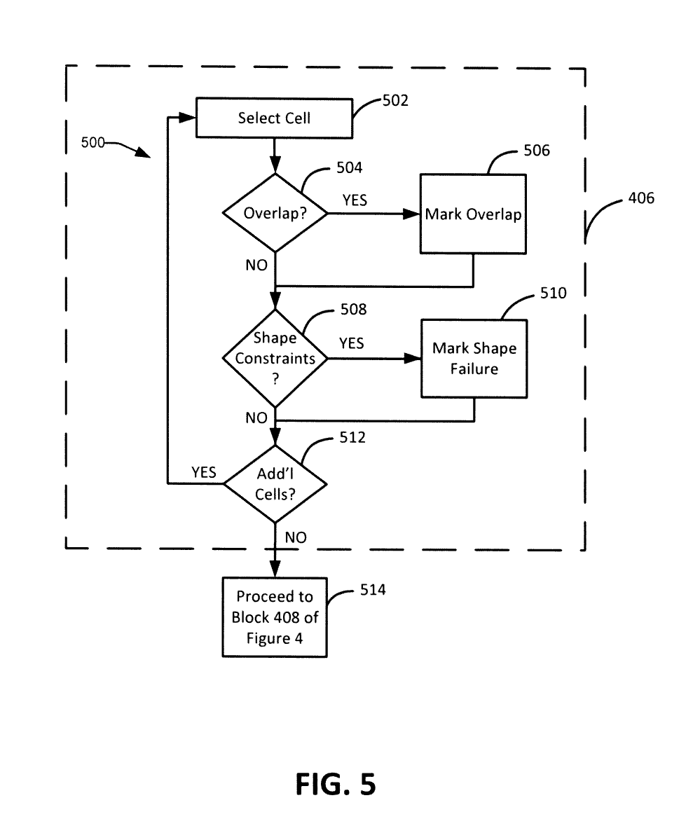

After the image data has been received and retopologized, the process proceeds to block 404, wherein steps 202 to 212 of FIG. 2 are performed as described above but on the data mesh. After the completion of steps 202-212, the process 400 proceeds to block 406, wherein one or several boundary errors are identified. A process 500 for identifying one or several boundary errors is shown in FIG. 5. This process 500 can be performed as part of block 406.

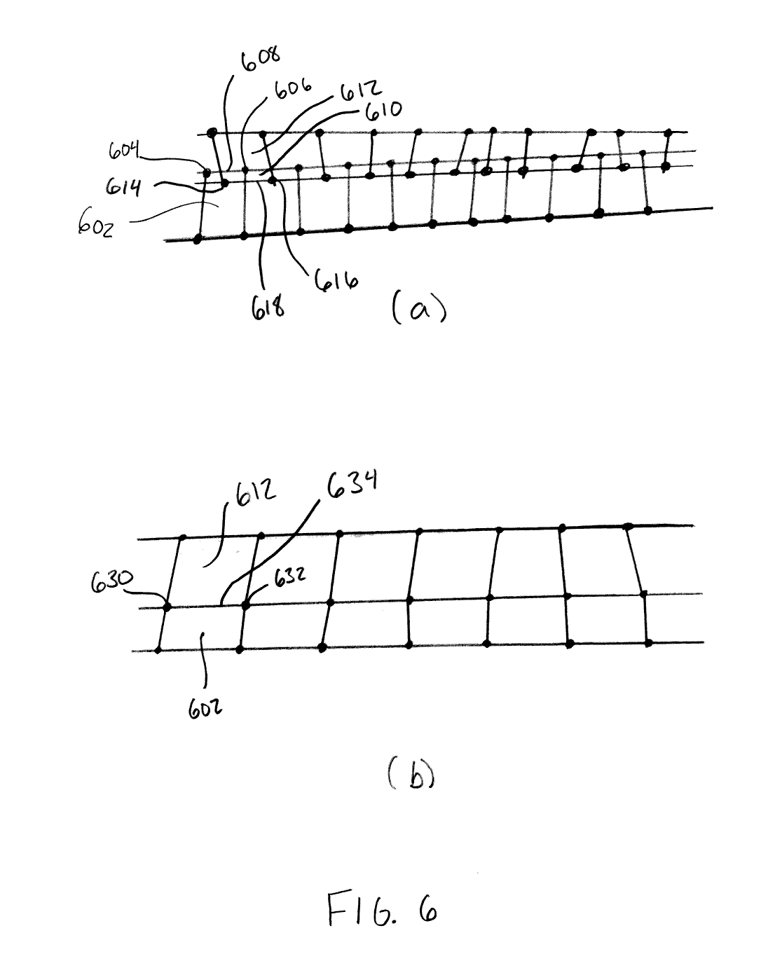

The process 500 begins at block 502, wherein a cell 306 is selected. In some embodiments the cell can be located along the boundary of the hole on the image data side or on the patch side. In some embodiments, the selected cell is a cell that has not been previously evaluated for boundary errors. After the cell has been selected, the process 500 proceeds to decision block 504, wherein it is determined if the selected cell overlaps other cells as is depicted in image (a) of FIG. 6. Image (a) of FIG. 6, a first cell 602 including a first node 604, a second node 606, and a first edge 608 overlaps a second cell 612 including a first node 614, a second node 616, and a first edge 618 so as to create an overlap region 610.

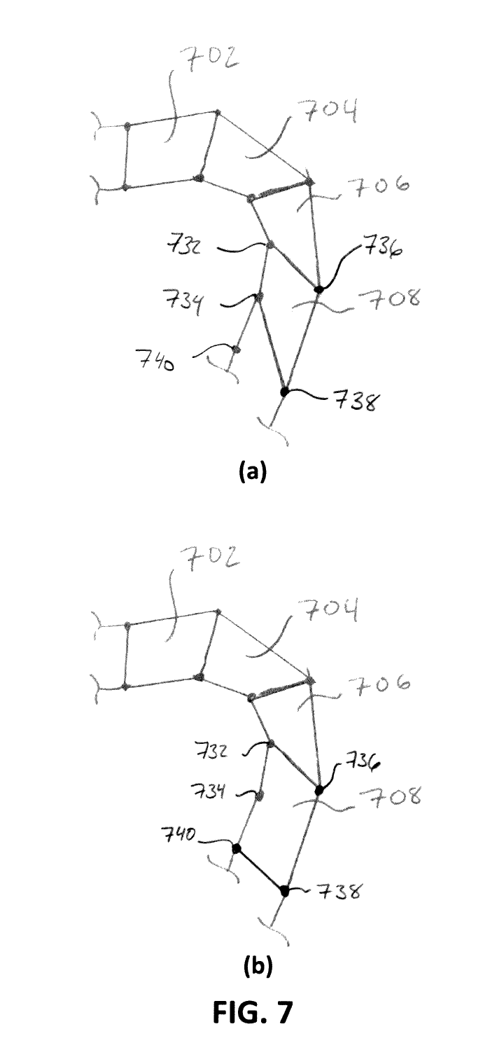

If it is determined that the selected cell overlaps a second cell, then the process 500 proceeds to block 506 and the overlap is marked. In some embodiments, the marking of the overlap can include associating a value indicative of the overlap with the selected cell. After the overlap has been marked, or returning again to decision block 504, if it is determined that the cell does not overlap other cells, the process 500 proceeds to decision block 508, wherein it is determine if the selected cell violates any shape constraints. In some embodiments, for example, the connection of the patch to the image data can result in the creation of one or several abnormally shaped cells. Such abnormally shaped cells are depicted in image (a) of FIG. 7, and particularly, image (a) of FIG. 7 depicts a first cell 702 that is approximately square shaped, a second cell 704 that is less square shaped than the first cell 702, a third cell 706 that is less square shaped than the second cell 704, and a fourth cell 708 that is less square shaped than the third cell 706. As seen in this image, due to the curvature of the hole boundary 308, the cells 702-708 become progressively less square shaped.

In some embodiments, the shape constraint can comprise one or several threshold value that can define between acceptably shaped cells and unacceptably shaped cells. These thresholds can relate to, for example, one or several angles, either internal or external, between edges of one cell, relative length or position of one edge of one cell with respect to one or several other edges of that one cell, or the like. In one embodiment, for example, the first, second, and third cells 702, 704, 706 may comply with the shape constraints, and the fourth cell 708 may violate the shape constraint.

If it is determined that the selected cell does not meet the shape constraints, then the process 500 proceeds to block 510, wherein the selected cell is marked as violating the shape constraints. In some embodiments, the marking of the overlap can include associating a value indicative of the overlap with the selected cell. After the selected cell has been marked, or returning again to decision block 508, if it is determined that the cell does not violate the shape constraints, then the process 500 proceeds to decision block 512, wherein it is determined if there are additional cells for evaluating. If it is determined that there are additional, unevaluated cells, then the process 500 returns to block 502, and proceeds as outlined above.

If it is determined that there are no additional cells, then the process 500 proceeds to block 514, and continues with block 408 of FIG. 4. Returning again to FIG. 4, after the one or several boundary errors are identified, the process 400 proceeds to block 408, wherein the identified boundary errors are resolved.

In the event that an overlap error is identified, the resolution of the boundary errors occurs as depicted in image (b) of FIG. 6. As seen in this image, the first node 604 of the first cell is consolidated with the first node 614 of the second cell 612 in new first node 630, the second node 606 of the first cell 604 is consolidated with the second node 616 of the second cell 612 in new second node 632, and the first edge 608 of the first cell 602 is consolidated with the first edge 618 of the second cell 612 in new first edge 634. In some embodiments, this consolidation can include the movement of one or more of one or both of the first nodes 604, 614, the second nodes 606, 616, and the first edges 608, 618.

In the event that a shape error is identified, the resolution of the boundary errors occurs as depicted in image (b) of FIG. 7. As seen in image (a) of FIG. 7, the fourth cell 708 is formed by a first node 732, a second node 734, a third node 736, and a fourth node 738. The fourth cell is further adjacent to a fifth node 740, which is outside of the fourth cell 708. In some embodiments, a failure of a cell to meet shape constraints can be remedied by increasing the number of nodes within the marked cell by at least one. Specifically, as shown in image (b) of FIG. 7, the fourth cell 708 is redrawn to include the fifth node 740, thereby forming a cell having five nodes and five edges, which redrawn fourth cell 708 complies with the shape constraints. After the boundary errors have been resolved, the process 500 proceeds to block 410, and continues with steps 214-220 as discussed above and as depicted in FIG. 2.

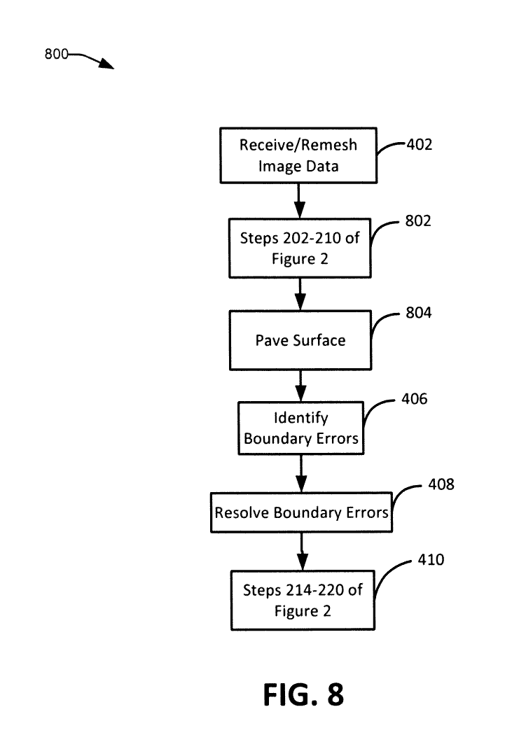

With reference now to FIG. 8, a flowchart illustrating one embodiment of a process 800 for simplifying retopologized data with paving is shown. The process begins at block 402, wherein image data is received and retopologized or re-meshed as discussed above with respect to block 402 of FIG. 4. After the image data is received and retopologized or re-meshed, the process 800 proceeds to block 802, wherein steps 202 to 210 of FIG. 2 are performed as described above but on the data mesh. After the completion of steps 202-210, the process 800 proceeds to block 804, wherein the fill surface is paved via the placement of points on the fill surface to create a mesh. In some embodiments, these points can be placed to create a mesh comparable to the mesh of the image data in that, for example, the cells created via paving have approximately the same size, shape, number of nodes and/or edges, or the like.

In some embodiments, paving can include identifying one or several existing nodes and/or edges and generating further nodes to connect with the one or several existing nodes to form one or several new cells. In some embodiments, these one or several nodes can be serially, one-after-another, created, and in other embodiments, at least some of these one or several nodes can be created in parallel.

After the paving has been completed, or while the paving is being performed as part of determining the placement of the one or several created nodes, the process 800 proceeds to block 406 and 408, wherein boundary errors are identified and resolved. These steps 406, 408 can be performed as discussed above with respect to FIGS. 4-7. In some embodiments, boundary errors are identified and resolved as part of the paving process. For example, after the paving process places each new node or other geometry, it can determine that a boundary error has been generated by the placement, and resolve the boundary error as discussed above before placing a next node or other geometry.

After the boundary errors have been resolved, the process 800 proceeds to block 410, and continues with steps 214-220 as discussed above and as depicted in FIG. 2.

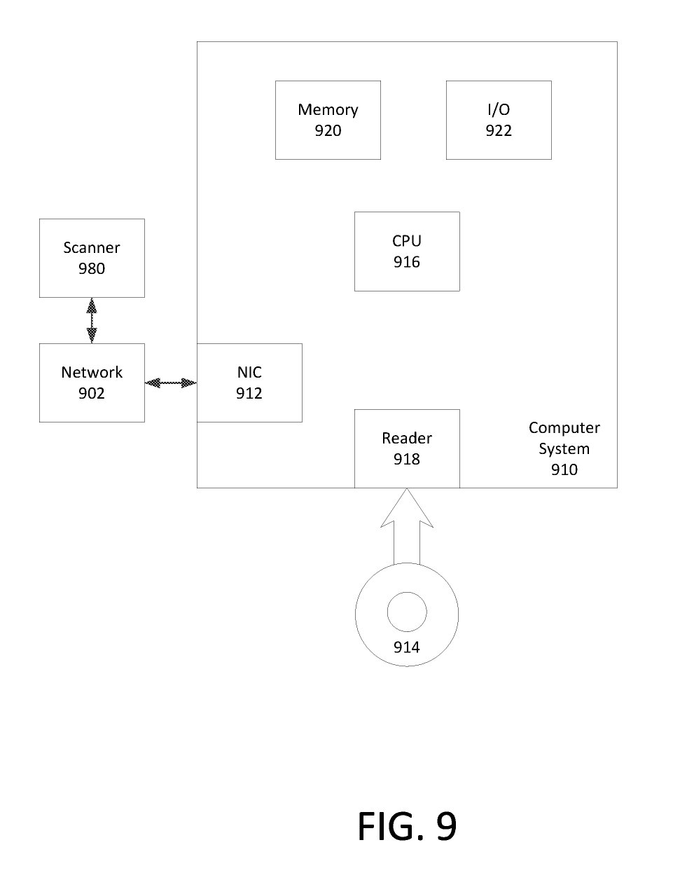

With reference now to FIG. 9, a configuration for a computer system 910 constructed in accordance with the present disclosure to perform the operations disclosed herein is shown. The computer system 910 can be linked to a scanner 980, for example, via network 902. The computer system 910 can comprise a system such as a personal computer or server computer or the like. The computer system 910 may include a network communication interface 912 that permits communications with the network 902. The network interface can comprise a network interface card (NIC). The computer system 910 can execute instructions to provide a computer system which performs various aspects and principles of the methods and features described herein. For example, each of the components of FIGS. 1-6 may be implemented by one or more of the computer systems 910.

The computer system 910 includes a central processor unit 916 (CPU) and a program product reader 918 for receiving a program product media and reading program instructions recorded thereon, where the instructions, when executed by the computer cause the computer to perform various aspects and principles of the methods and features described herein. The computer system also includes associated memory 920 and input/output facilities 922, such as a display for output and a keyboard and/or mouse for input. The processor 916 of the computer system 910 can receive program instructions into the program memory of the processor. The program instructions can be received directly, such as by flashing EEPROM of the processor, or can be received through the network interface 912, such as by download from a connected device or over a WAN or LAN network communication. If desired, the program instructions can be stored on a computer program product 914 that is read by the computer system 910 so that the program instructions can thereafter executed. That is, the program product 914 is for use in a system such as the computer system 910, wherein the program product comprises a tangible, non-transitory recordable media containing a program of computer-readable instructions that are executable by the device processor 904 to perform the operations described herein. The program product 914 can comprise, for example, optical program media such as CD or DVD data discs, or flash memory drives, or external memory stores, or floppy magnetic disks, and the like.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of hole refilling, the method comprising:
receiving scanned image data, wherein the scanned image data represents a tangible object, and wherein the scanned image data is generated by an object scanner from the tangible object;
converting the scanned image data to polygonal data, wherein the polygonal data comprises a collection of vertices, edges and faces;
identifying a geometry in the polygonal data for hole cutting, wherein the identified geometry is specified by a user;
cutting a hole by removing the identified geometry from the scanned image data;
generating modified polygonal data by filling the cut hole with polygonal data, wherein filling the hole comprises attaching a polygonal surface to the cut hole, wherein the polygonal surface is continuous with the image data around the hole; and
outputting the modified polygonal data.

2. The method of claim 1, wherein the object scanner is a 3D object scanner.

3. The method of claim 1, further comprising identifying a continuous surface, wherein the continuous surface is continuous at all locations around the hole when applied to the hole.

4. The method of claim 3, wherein the polygonal surface is adjusted to match the continuous surface.

5. The method of claim 4, wherein the polygonal surface is G2 continuous with the image data around the hole.

6. The method of claim 4, wherein the polygonal surface is G3 continuous with the image data around the hole.

7. The method of claim 6, further comprising smoothing the polygonal surface.

8. The method of claim 7, wherein the polygonal surface is smoothed via a Catmull-Clark subdivision.

9. A non-transitory computer readable medium storing computer executable program code for hole refilling, the non-transitory computer readable medium comprising:
code for receiving scanned image data, wherein the scanned image data represents a tangible object, and wherein the scanned image data is generated by an object scanner from the tangible object;
code for converting the scanned image data to polygonal data, wherein the polygonal data is a collection of vertices, edges and faces;
code for identifying geometry in the polygonal data for hole cutting, wherein the identified geometry is specified by a user;
code for cutting a hole by removing the identified geometry from the scanned image data;
code for generating modified polygonal data by filling the cut hole with polygonal data, wherein filling the hole comprises attaching a polygonal surface to the cut hole, wherein the polygonal surface is continuous with the image data around the hole; and
code for outputting the modified polygonal data.

10. The non-transitory computer readable medium of claim 9, wherein the object scanner is a 3D object scanner.

11. The non-transitory computer readable medium of claim 9, further comprising code for identifying a continuous surface, wherein the continuous surface is continuous at all locations around the hole when applied to the hole.

12. The non-transitory computer readable medium of claim 11, wherein the polygonal surface is adjusted to match the continuous surface.

13. The non-transitory computer readable medium of claim 12, wherein the polygonal surface is G2 continuous with the image data around the hole.

14. The non-transitory computer readable medium of claim 12, wherein the polygonal surface is G3 continuous with the image data around the hole.

15. The non-transitory computer readable medium of claim 14, further comprising code for smoothing the polygonal surface.

16. The non-transitory computer readable medium of claim 15, wherein the surface is smoothed via a Catmull-Clark subdivision.

17. A system for refilling a hole generated in image data, the system comprising:
an object scanner configured to generate scanned image data of a tangible object;
memory comprising stored instructions configured to control a processor to:
receive scanned image data, wherein the scanned image data represents a tangible object, and wherein the scanned image data is generated by the object scanner from the tangible object;
convert the scanned image data to polygonal data, wherein the polygonal data is a collection of vertices, edges and faces;
identify geometry in the polygonal data for hole cutting, wherein the identified geometry is specified by a user;
cut a hole by removing the identified geometry from the scanned image data;
generate modified polygonal data by filling the cut hole with polygonal data, wherein filling the hole comprises attaching a polygonal surface to the cut hole, wherein the polygonal surface is continuous with the image data around the hole; and
output the modified polygonal data; and
a processor controllable according to the stored instructions.

18. The system of claim 17, wherein the object scanner is a 3D object scanner.

19. The system of claim 17, wherein the stored instructions are further configured to control the processor to identify a continuous surface, wherein the continuous surface is continuous at all locations around the hole when applied to the hole.

20. The system of claim 19, wherein the polygonal surface is adjusted to match the continuous surface.
